(19) United States
(12) Patent Application Publication
(10) Pub. No.: US 2003/0230328 A1
(43) Pub. Date: Dec. 18, 2003

(54) Self-positioning structure with adjustable frame body

(76) Inventor: Tung-I Chen, Taipei (TW)

Correspondence Address: Tung-I Chen, P.O. Box 82-144, Taipei, TW

(21) Appl. No.: 10/167,958

(22) Filed: Jun. 13, 2002

(51) Int. Cl. A61H 3/00

(52) U.S. Cl. 135/67

(57) ABSTRACT

A self-positioning structure with adjustable frame body is disclosed. The structure comprises a main frame body and a rotating body pivotally mounted to each other, characterized in that a pivotal sleeve is mounted to the main frame body and the upper section of the interior of the pivotal sleeve is a pivotal shaft for pivoting the rotating frame body, and the bottom end of the pivotal sleeve is mounted with a teethed sleeve inserted to the interior thereof, one end of the rotating body is downwardly formed into an extension section for inserting into the pivotal shaft, and the extension section is inserted beyond one end of the pivotal shaft and is mounted with a teethed block, a compression spring is supported by the teethed block and the bottom end of the pivotal shaft, and the teethed block is in engagement with the teethed sleeve, thereby a self-positioning structure with accurate angle of positioning angle is obtained.

### BACKGROUND OF THE INVENTION

(a) Field of the Invention

The present invention relates to structure of a self-positioning structure, and in particular to a structure where the frame body can be conveniently positioned.

(b) Description of the Prior Art

Conventional self-positioning structure is shown in FIGS. 1 and 2. In operation, a wrench 16 has to be turned upward so that the teethed block 25 is disengaged with the teethed-face 15, and the rotating frame 20 can be adjusted. When the rotating frame 20 has rotated to the desired angle, the wrench 16 has to be placed downward, and the teethed block 25 and the teethed-face 15 are in engagement again, so as to achieve the adjustment of the rotating frame body.

However, the conventional structure has the following drawbacks: (a) Inconvenient in Operation: In this operation both hands of the user have to be employed and it is not convenient for injured person or sick person where one of the hands may not be conveniently used, (b) The angle of adjustment is not accurate: When the user has adjusted the rotating frame body to an appropriate angle, the wrench 16 has to be operated in order to position the structure, and a careless movement of the hand will cause the angle of adjustment being inaccurate, (c) The angle of rotating is small. Due to the thickness of blocks 121, 122, the angle of adjustment for the rotating frame body is about 90 only. Accordingly, it is an object of the present invention to provide a self-positioning structure with adjustable frame which mitigates the above drawbacks.

### SUMMARY OF THE INVENTION

Accordingly, it is an object of the present invention to provide a self-positioning structure with adjustable frame body comprising a main frame body and a rotating body pivotally mounted to each other, characterized in that a pivotal sleeve is mounted to the main frame body and the upper section of the interior of the pivotal sleeve is a pivotal shaft for pivoting the rotating frame body, and the bottom end of the pivotal sleeve is mounted with a teethed sleeve inserted to the interior thereof, one end of the rotating body is downwardly formed into an extension section for inserting into the pivotal shaft, and the extension section is inserted beyond one end of the pivotal shaft and is mounted with a teethed block, a compression spring is supported by the teethed block and the bottom end of the pivotal shaft, and the teethed block is in engagement with the teethed sleeve, thereby a self-positioning structure with accurate angle of positioning angle is obtained.

Another object of the present invention is to a self-positioning structure with adjustable frame body, wherein a user can use a single hand to lift up the rotating frame body to adjust the angle, and when the hand is released, the rotating frame is self-positioned. Accordingly, the operation of positioning is conveniently achieved and the angle of positioning is accurate, and at the same time, the adjusted angle of the rotating frame is improved.

Other objects, advantages, and novel features of the invention will become more apparent from the following description when taken in conjunction with the accompanying drawings.

### BRIEF DESCRIPTION OF THE DRAWINGS

FIG. 1 is a perspective exploded view of a conventional self-positioning structure, showing the components and the relative position.

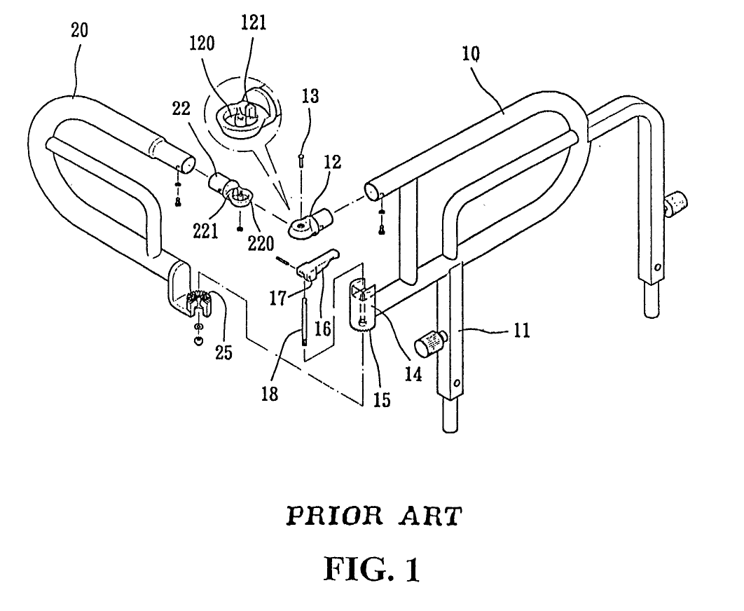

FIG. 2 is a schematic view of the conventional self-positioning frame showing the rotating body on the adjusting knot of the structure.

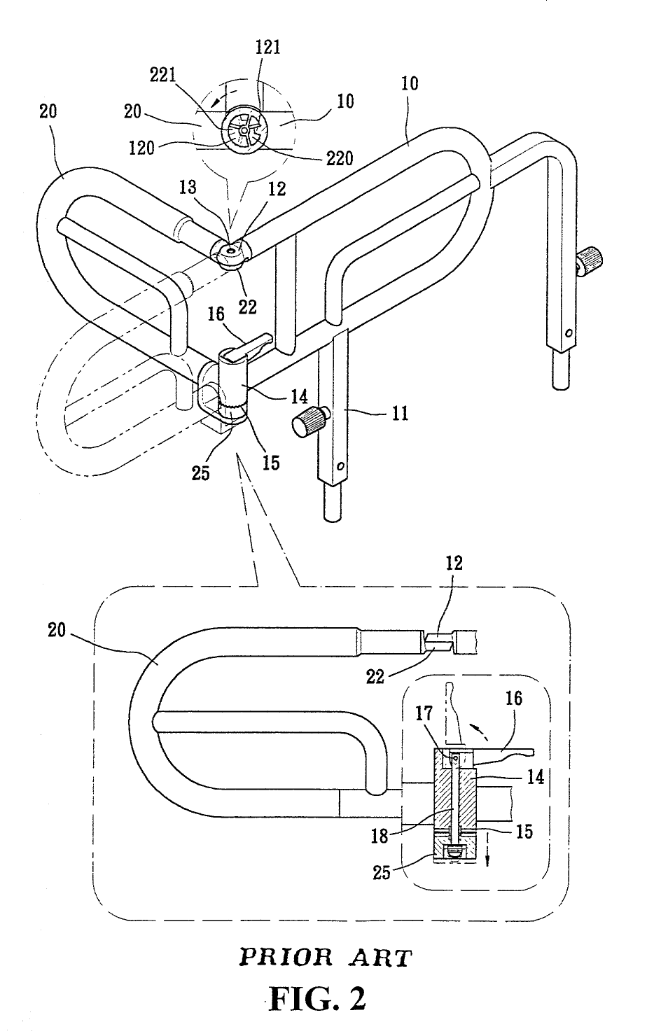

FIGS. 3 is a perspective exploded view of a self-positioning structure, showing the components and the relative position, in accordance with the present invention.

FIG. 4 is a sectional view of the self-positioning structure accordance with the present invention.

FIG. 5 is a schematic sectional view of the self-positioning structure, showing the relative position of the components in the course of adjusting movement in accordance with the present invention.

FIG. 6 is perspective view of the self-positioning structure when in use accordance with the present invention.

### DETAILED DESCRIPTION OF THE PRESENT INVENTION

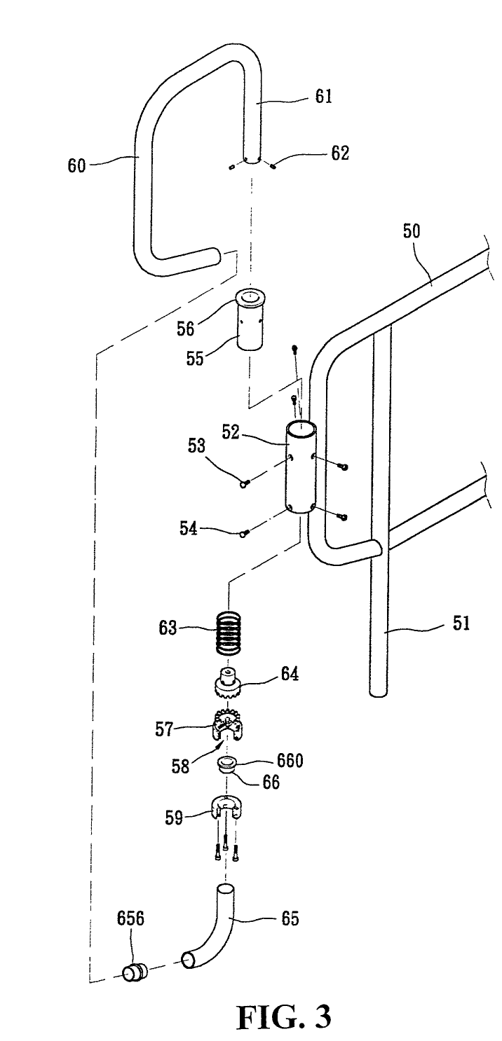

Referring to FIG. 3, there is shown a self-positioning structure with adjustable frame body comprising a main frame body 50 and a rotating frame body 60 pivotally mounted with each other. The main frame body 50 is extended downwardly for the mounting of a fixing rod 51. The rotating frame body 60 is rotatable or positioned with respect to the main frame body 50.

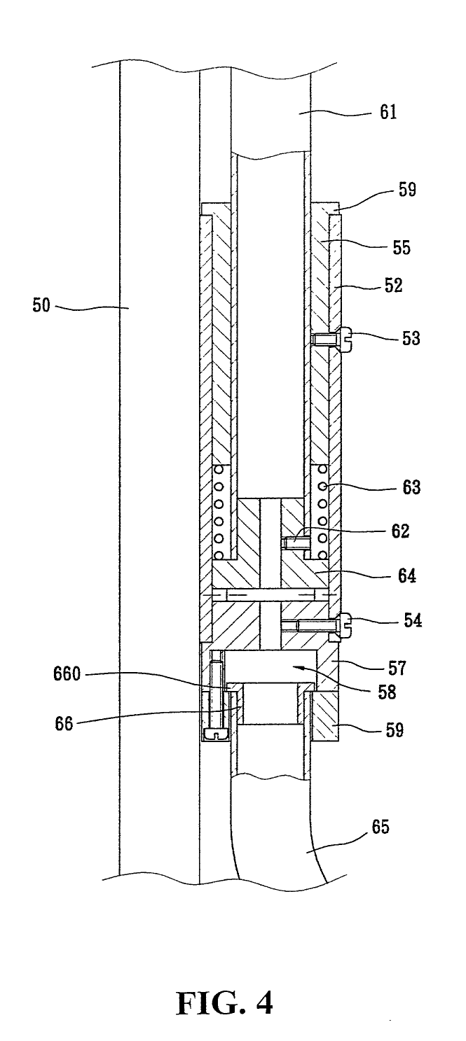

Referring to FIGS. 3 and 4, the main frame 50 corresponding to one lateral side of the rotating body 60 is provided with a hollow pivotal sleeve 52. The upper section of the interior of the pivotal sleeve 52 is mounted with a pivotal shaft 55 with a bolt 53. The top end of the pivotal shaft 55 is protruded with a resisting edge 56 which can resist the top edge of the pivotal sleeve 52. The bottom end of the pivotal sleeve 52 makes use of a bolt 54 to mount a teethed sleeve 57 which has been inserted into the interior thereof. The bottom face of the teethed sleeve 57 is formed into a cavity 58 and the bottom end of the teethed sleeve 57 is provided with a seal 59 having a size smaller than that of the cavity 58 for the mounting of the rotating frame 60. In accordance with the present invention, one end of the rotating body 60 is downwardly formed into an upright, extension section 61 for inserting into the pivotal shaft 55, and the extension section 61 is inserted beyond one end of the pivotal shaft 55 and is mounted with a teethed block 64. A compression spring 63 is supported by the teethed block 64 and the bottom end of the pivotal shaft 55, and the teethed block 64 is in engagement with the teethed sleeve 57. The other end of the rotating frame body 60 employs a connector 650 to mount an upward-extended elbow tube 65, and a protruded block 66 is mounted to the elbow tube 65 after the tube 65 passes the seal 59, and the top edge of the protruded block 66 is a lip edge 660 which urges the top face of the seal 59. Accordingly, a self-positioning structure with accurate angle of positioning angle is obtained.

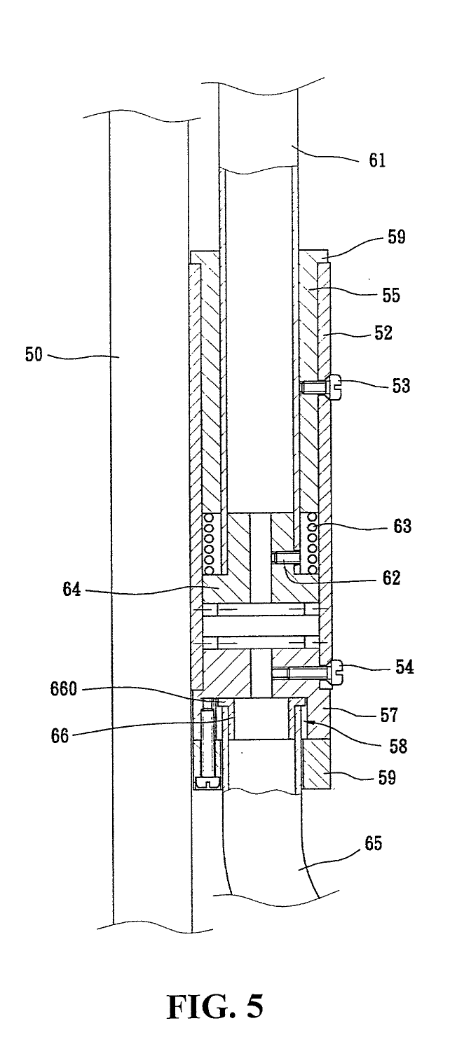

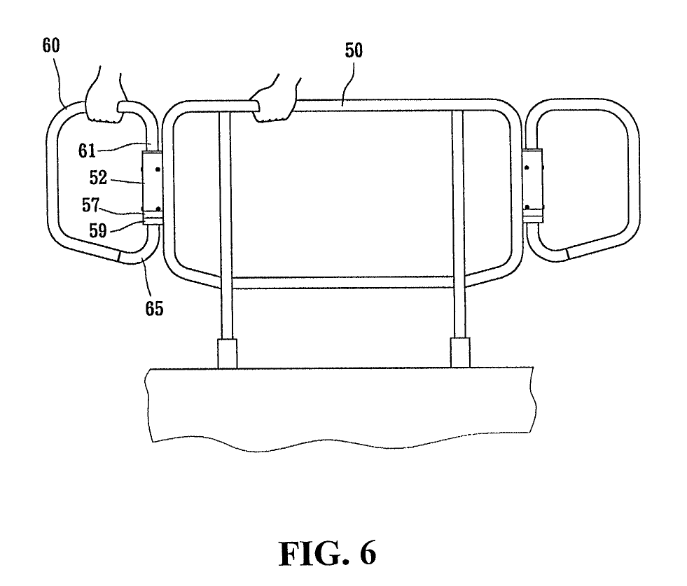

When in use, referring to FIGS. 4, 5, and 6, one hand of the user holds the main frame 50 and the other hand lift up the main frame 60, the teethed block 64 presses against the compression spring 63 and the teethed block 64 disengaged from the teethed sleeve 57 of the pivotal sleeve 52, and the lip edge 660 is also away from the seal 59. Thus the user can adjust the angle of the rotating frame 60 and when the rotating frame 60 is at an appropriate angle, the user then puts down the rotating frame body 60 and the teethed block 64 is again in engagement with the teethed sleeve 57. At the same time, the lip edge 660 urges the top face of the seal 59 and the user can thus adjust the angle of the rotating body 60 with a single hand.

The advantages of the present invention are as follows:

(a) Convenient in Operation: The compression spring 63 allows the self-positioning of the rotating frame 60 and the operation can be achieved with a single hand. The operation is easy and convenient and rapid.

(b) Angle of positioning is accurate. As the rotating frame 60 is self-restoration to it position thereof, after the angle has been determined, the user can single handed release the rotating frame 60 and the positioning of the rotating frame 60 is at the most accurate position.

(c) Wide angle of adjustment: As there is no restriction by blocking parts, the angle of adjustment is at about 300 degree.

While the invention has been described with respect to a preferred embodiment, it will be clear to those skilled in the art that modifications and improvements may be made to the invention without departing from the spirit and scope of the invention. Therefore, the invention is not to be limited by the specific illustrative embodiment, but only by the scope of the appended claims

I claim:

1. A self-positioning structure with adjustable frame body comprising a main frame body and a rotating body pivotally mounted to each other, characterized in that a pivotal sleeve is mounted to the main frame body and the upper section of the interior of the pivotal sleeve is a pivotal shaft for pivoting the rotating frame body, and the bottom end of the pivotal sleeve is mounted with a teethed sleeve inserted to the interior thereof, one end of the rotating body is downwardly formed into an extension section for inserting into the pivotal shaft, and the extension section is inserted beyond one end of the pivotal shaft and is mounted with a teethed block a compression spring is supported by the teethed block and the bottom end of the pivotal shaft, and the teethed block is in engagement with the teethed sleeve, thereby a self-positioning structure with accurate angle of positioning angle is obtained.

2. The self-positioning structure of claim 1, wherein the top end of the main frame body is protruded with a resisting edge which can resist the top edge of the pivotal sleeve, and the pivotal sleeve employs a bolt to lock with the pivotal shaft.

3. The self-positioning structure of claim 1, wherein the pivotal sleeve of the main frame body employs a bolt to lock with the teethed sleeve.

4. The self-positioning structure of claim 1, wherein the rotating frame body employs a bolt to lock with the teethed block.

5. The self-positioning structure of claim 1, wherein the bottom face of the teethed sleeve is formed into a larger cavity and the bottom end of the teethed sleeve is mounted with a seal of size smaller than the cavity, and the other end of the rotating frame body employs a connector to mount an upward-extended elbow tube, and a protruded block is mounted to the elbow tube after the tube passes the seal, the top edge of the protruded block is a lip edge which urges the top face of the seal.

6. The self-positioning structure of claim 1, wherein the bottom end of the teethed sleeve uses a bolt to lock with the seal.
